(19) United States
(12) Patent Application Publication
(10) Pub. No.: US 2010/0270904 A1
(43) Pub. Date: Oct. 28, 2010

(54) LED BULB WITH MODULES HAVING SIDE-EMITTING DIODES

(75) Inventor: Steven KIM, Riverdale, NJ (US)

Correspondence Address: HOLLAND & KNIGHT LLP, 2099 PENNSYLVANIA AVE, SUITE 100, WASHINGTON, DC, 20006, US

(73) Assignee: LED FOLIO CORPORATION, Riverdale, NJ (US)

(21) Appl. No.: 12/541,690

(22) Filed: Aug. 14, 2009

Related U.S. Application Data
(60) Provisional application No. 61/173,488, filed on Apr. 28, 2009.

(51) Int. Cl. H01J 61/52; H01J 5/48

(52) U.S. Cl. 313/46; 313/318.01

(57) ABSTRACT

A light emitting diode bulb includes: a base having a screw-in type electrical connector at a first end of the base; a power converter in the base for converting alternating current voltage into direct current voltage; a plurality of light emitting diode modules stacked on the base, wherein each of the light emitting diode modules have a plurality of side-emitting light emitting diodes; and a cover surrounding the plurality of light emitting diode modules stacked on the base.

This invention claims the benefit of U.S. Provisional Patent Application No. 61/173,488 filed on Apr. 28, 2009, which is hereby incorporated by reference in its entirety.

### BACKGROUND OF THE INVENTION

1. Field Of The Invention

The embodiments of the invention relate to a light emitting diode (hereinafter “LED”) bulb, and more particularly, to a LED bulb with modules having side-emitting LEDs. Although embodiments of the invention are suitable for a wide scope of applications, they are particularly suitable for lighting applications that can otherwise use compact fluorescent bulbs or incandescent bulbs.

2. Discussion Of The Related Art

In general, the LED bulb is more energy efficient than either an incandescent bulb or a compact fluorescent bulb. An incandescent bulb converts about 3 percent of the supplied power into light at about 14-16 lumens/watt. A compact fluorescent bulb converts about 12% of the supplied power into light at about 60-72 lumens/watt. An LED bulb converts about 18% of the supplied power into light at about 93-95 lumens/watt. The rest of the supplied power for each of the incandescent bulb, the compact fluorescent bulb and the LED bulb is usually expended as heat.

An incandescent bulb uses a filament to create light. A compact fluorescent bulb uses a gas excited by an electric field to create light. An LED bulb uses one or more LEDs in which each of the LEDs uses a semiconductor chip to create light. Because the LED bulb uses a semiconductor chip, the LED bulb can have a much longer life term than either an incandescent bulb or a compact fluorescent bulb.

The heat expended from the LED of an LED bulb is generated inside the semiconductor chip adjacent to the junction of different types of semiconductor materials. As the temperature rises in the semiconductor chip of an LED in the LED bulb, the light conversion efficiency can actually decrease as the input power is increased. Also, as the semiconductor chip of an LED is exposed to long periods of high temperatures, the life-span of the LEDs within the LED bulb decrease and/or the brightness of the LEDs within the LED bulb permanently drops.

Because heat is generated within the semiconductor chip of an LED, heat must be conducted out of the semiconductor chip via a path of low heat resistance. Such heat conduction or heat dissipation keeps the LED chip at a nominal temperature such that the LED will function most efficiently and have a long term life-span. A heat sink is typically used to conduct or dissipate heat away from the LED(s) in an LED light bulb.

Incandescent bulbs come in different light output capabilities, different shapes, different sizes and different types of screw-in type electrical connections. Although a compact fluorescent bulb is a completely different light technology than the incandescent bulb, compact fluorescent bulbs have been manufactured to have many of the same light output capacities as well as the same size, shape and screw-in type electrical connections as incandescent bulbs. Attempts have been made to the same with LED bulbs but the need for heatsinks has made such previously attempted LED bulbs unsightly or unworkable. Also, previously attempted LED bulbs have provided unidirectional light or poorly dispersed light in comparison to an incandescent bulb or a compact fluorescent bulb.

### SUMMARY OF THE INVENTION

Accordingly, embodiments of the invention are directed to an LED bulb with modules having side-emitting LEDs that substantially obviates one or more of the problems due to limitations and disadvantages of the related art.

An object of embodiments of the invention is to provide an LED bulb that uniformly disperses light.

Another object of embodiments of the invention is to provide an LED bulb that dissipates heat from each of the LEDs.

Another object of embodiments of the invention is to maintain the efficiency of LEDs in an LED bulb.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a light emitting diode bulb includes: a base having a screw-in type electrical connector at a first end of the base; a power converter in the base for converting alternating current voltage into direct current voltage; a plurality of light emitting diode modules stacked on the base, wherein each of the light emitting diode modules have a plurality of side-emitting light emitting diodes; and a cover surrounding the plurality of light emitting diode modules stacked on the base.

In another aspect, the light emitting diode bulb includes: a base having an electrical connector at a first end; a pillar extending from a second end of the base opposite to the first end of the base; a power converter in the base for converting alternating current voltage into direct current voltage; a plurality of light emitting diode modules stacked on the base and surrounding the pillar, wherein each of the modules have a plurality of side-emitting light emitting diodes; and a cover surrounding the plurality of light emitting diode modules.

In yet another aspect, a light emitting diode bulb includes: a base having an electrical connector at a first end; a pillar extending from a second end of the base opposite to the first end of the base; a power converter in the base for converting alternating current voltage into direct current voltage; a first light emitting diode module having a first inner periphery surrounding the pillar and a first outer periphery opposite to the first inner periphery; a first plurality of side-emitting light emitting diodes at the first outer periphery; and a cover surrounding the first light emitting diode module.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an assembly view of an LED bulb according to a first exemplary embodiment of the invention;

FIG. 2a is a top view of an LED module;

FIG. 2b is a side view of an LED module;

FIG. 3 is an assembly view of an LED module;

FIG. 4a is a top view of a circuit board with parallel connected LEDs;

FIG. 4b is a bottom view of a circuit board with parallel connected LEDs;

FIG. 5 is a side view of an LED bulb according to the first exemplary embodiment of the invention;

FIG. 6 is a cross-sectional view of an LED bulb according to the first exemplary embodiment of the invention;

FIG. 7 is a cross-sectional view of an LED bulb showing air flow according to the first exemplary embodiment of the invention;

FIG. 8a is a top view of a slotted circuit board with parallel connected LEDs;

FIG. 8b is a bottom view of a slotted circuit board with parallel connected LEDs;

FIG. 9a is a top view of a circuit board with groups of serially connected LEDs;

FIG. 9b is a bottom view of a circuit board with groups of serially connected LEDs;

FIG. 10 is an assembly view of an LED bulb according to the second exemplary embodiment of the invention;

FIG. 11 is a side view of an LED bulb according to a second exemplary embodiment of the invention;

FIG. 12 is a cross-sectional view of an LED bulb according to the second exemplary embodiment of the invention;

FIG. 13 is a cross-sectional view of an LED bulb showing air flow according to the second exemplary embodiment of the invention;

FIG. 14a is a side view of an LED bulb according to a third exemplary embodiment of the invention;

FIG. 14b is a top view of an LED bulb according to the third exemplary embodiment of the invention;

FIG. 15 is a cross-sectional view of an LED bulb according to the third exemplary embodiment of the invention; and

FIG. 16 is a cross-sectional view of an LED bulb showing air flow according to the third exemplary embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

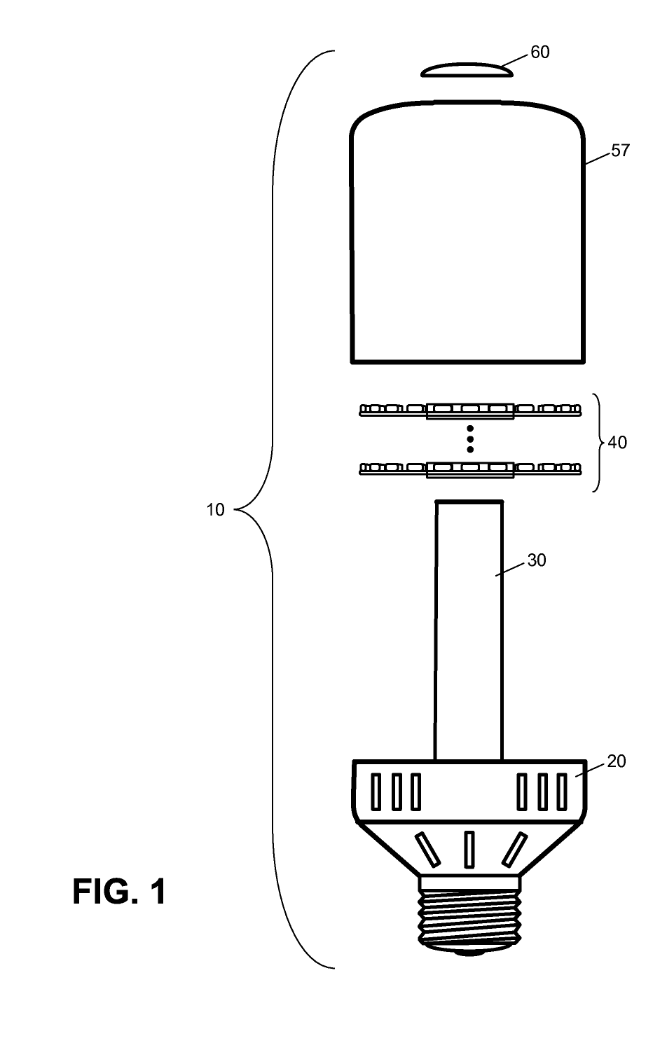

FIG. 1 is an assembly view of an LED bulb according to a first exemplary embodiment of the invention. As shown in FIG. 1, an LED bulb 10 has a base 20 from which a pillar 30 extends, a plurality of LED modules 40 are stacked on the base 20 to surround the pillar 30, a cover 57 is placed over the stacked LED modules, and a cap 60 attaches to the pillar 30 to secure the cover 57. The assembled LED bulb 10 can be somewhat similar in size and shape to a typical incandescent bulb or a typical compact fluorescent bulb.

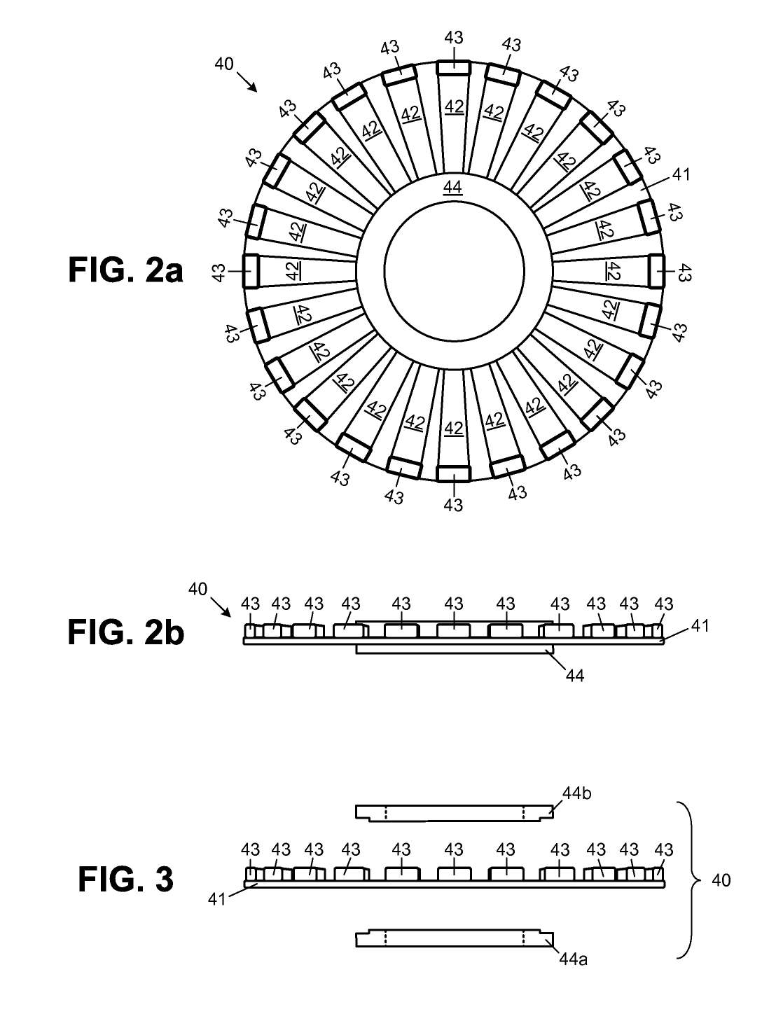

FIG. 2a is a top view of an LED module and FIG. 2b is a side view of an LED module. As shown in FIG. 2a, an LED module 40 includes a circuit board 41 with electrical traces 42, side-emitting LEDs 43 mounted on the circuit board at one end of the electrical traces 42, and interboard connector 44 at the other end of the electrical traces 42. Heat generated by the side-emitting LEDs 43 can be transferred through the electrical traces 42 to the interboard connector 44. Further, heat being transferred into the electrical traces 42 from the side-emitting LEDs can be radiated into the air by the electrical traces 42.

The side-emitting LEDs 43 are electrically connected to the electrical traces 42. The interboard connector 44 has conductors (not shown) that connect to the electrical traces 42 and run to the upper and lower surfaces of the interboard connector 44 such that direct current voltage can be supplied to the side-emitting LEDs 43 of an LED module 40 from an adjoining interboard connector or a power converter. Thus, the conductors (not shown) of the interboard connector 44 are configured such that a plurality of LED modules can be stacked upon each other and adjoining interboard connectors will provide direct current voltage to all of the side-emitting LEDs in the stack of LED modules.

As shown in FIG. 2b, the interboard connector 44 extends above and below the circuit board 41 of the LED module 40. Upon stacking a plurality of LED modules 40, only the interboard connector 44 of each LED module 40 contacts the interboard connector 44 of another LED module 40. Thus, the interboard connector 44 provides a spacing or gap between the circuit boards 41 and the side-emitting LEDs 43 of adjacent LED modules 40.

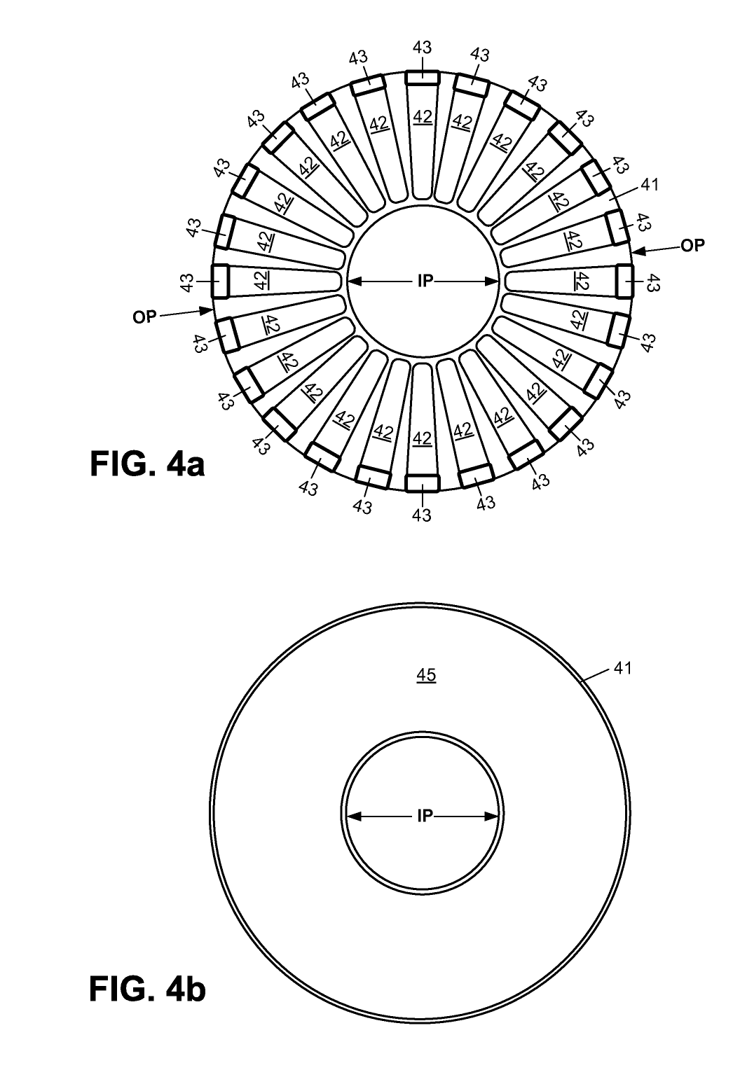

FIG. 3 is an assembly view of an LED module. As shown in FIG. 3, interboard connector 44 can have a lower portion 44a and a top portion 44b that are joined together onto the electrical traces 42 of the circuit board 41. By assembling the lower and upper portions 44a and 44b of the interboard connector 44 onto the circuit board 41, the interboard connector 44 can provide spacing between LED modules 40, power to the side-emitting LEDs 43 of the modules 40 through the electrical traces 42 and receive heat from the side-emitting LEDs 43 through the electrical traces 42.

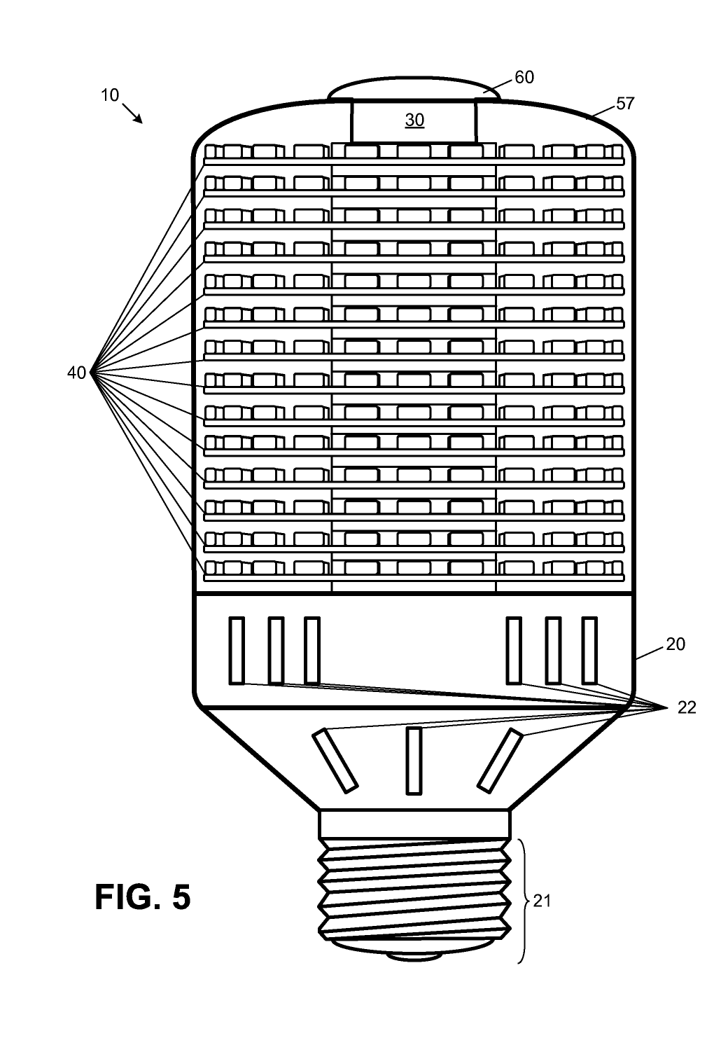

FIG. 4a is a top view of a circuit board with parallel connected LEDs and FIG. 4b is a bottom view of a circuit board with parallel connected LEDs. As shown in FIG. 4a, a circuit board 41 has an inner periphery IP and an outer periphery OP. Electrical traces 42 on the circuit board 41 have a radial pattern running from the inner periphery IP to the outer periphery OP of the circuit board 41. The electrical traces 42 are relatively wide such that heat from the side-emitting LEDs 43 transferred into the electrical traces 42 can be radiated into the air. As shown in FIG. 4b, a backplane electrode 45 covers most of the side of the circuit board 41 opposite to the side having the radial electrical traces 42.

The LEDs 43 at the outer periphery of the circuit board 41 are side-emitting LEDs in that light generally emanates from the LEDs 43 in the same radial direction as the electrical trace on which an LED is mounted. The light of the side-emitting LEDs 43 is directed outward away from the circuit board 41 such that light is not directed at another circuit board when modules including the circuit boards are stacked, as shown in FIG. 1. By using side-emitting LEDs 43, which generally emit light in radial direction away from the circuit board 41, light efficiency is improved since all light is generally emitted in direction through the cover 47 when modules including the circuit boards are stacked, as shown in FIG. 1.

The side-emitting LEDs 43 are two terminal devices in which one terminal of each of the side-emitting LEDs 43 is connected one of the electrical traces 42. The other terminal of each of the side-emitting LEDs 43 is connected to the backplane electrode 45 on the other side of the circuit board 41, as shown in FIG. 4a. Because the side-emitting LEDs 43 are respectively connected to the electrical traces 42 and commonly connected to the backplane electrode 45, the side-emitting LEDs 43 can be supplied direct current voltage in parallel to each other. An electrical failure in one LED on the circuit board 41 of parallel connected LEDs will not effect the operation of the other LEDs on the circuit board 41.

The electrical traces 42 and the backplane electrode 45 are formed of a metal or a metal alloy, such as aluminum or a copper alloy. The metal or metal alloy dissipates heat from the side-emitting LEDs 43 and transfers heat from the side-emitting LEDs 43 to the interboard connector 44. Although the backplane electrode 45 does not directly receive heat transfer from the side-emitting LEDs 43, the backplane electrode 45 can absorb heat through the circuit board 41 and radiate that heat into the air.

The side-emitting LEDs 43 at the outer periphery OP of the circuit board are less than a half of a watt, such as 0.064 watt. Typically, LEDs designed to output light at less than a half of a watt have a higher energy to light conversion efficiency than LEDs designed to output light at greater than a half of a watt. For example, if the twenty four side-emitting LEDs 43 in FIG. 4a were 0.064 watt side-emitting LEDs such that the sum power usage is about 1.5 watts, the twenty four 0.064 watt side-emitting LEDs would have higher light output than a single 1.5 watt LED. In such an example, the single 1.5 watt LED would also require a large unsightly external heatsink as opposed to the twenty four 0.064 watt side-emitting LEDs 43 that use electrical traces 42 as internal heatsinks.

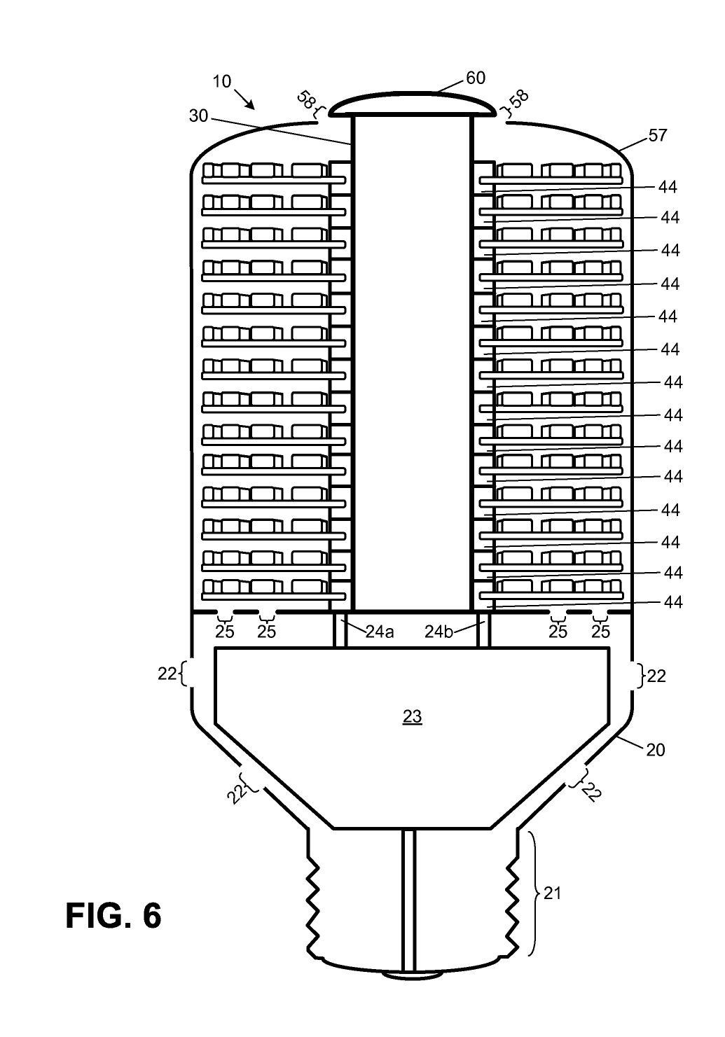

FIG. 5 is a side view of an LED bulb according to the first exemplary embodiment of the invention. As shown in FIG. 5, an LED bulb 10 has a base 20 from which a pillar 30 extends, a plurality of LED modules 40 stacked on the base 20 around the pillar 30, a cover 57 encapsulating the stacked LED modules, and a cap 60 attached to the pillar 30 to secure the cover 57. The pillar 30 is at one end of the base 20 and a screw-in type electrical connector 21 is located at the opposite end of the base 20. For example, the screw-in type electrical connector 21 can be an Edison E27 screw-in type connector. The base has openings 22 in the sides of the base 20 between the pillar 30 and the screw-in type electrical connector 21.

The cover 57 can be either translucent or transparent. For example, a translucent cover can have a diffusion coating on the inside surface and/or outside surface of the cover to diffuse the light emitted from the side-emitting LEDs of the LED modules 40. In another example, a translucent cover can have a phosphor coating on the inside surface and/or outside surface of the cover to convert ultraviolet light emitted from the side-emitting LEDs of the LED modules 40 into visible light.

As shown in FIG. 5, all of the LED modules 40 in the first exemplary embodiment have the same diameter and the same number of side-emitting LEDs on each of the LED modules 40. However, embodiments of the invention can contain a plurality of modules in which at least some the LED modules have different diameters and a different number of side-emitting LEDs. For example, an LED bulb may first have six modules that are about three inches wide with twenty-four side-emitting LEDs and modules with successively decreasing numbers of side-emitting LEDs and successively decreasing diameters down to an LED module that is about one inch wide with six side-emitting LEDs.

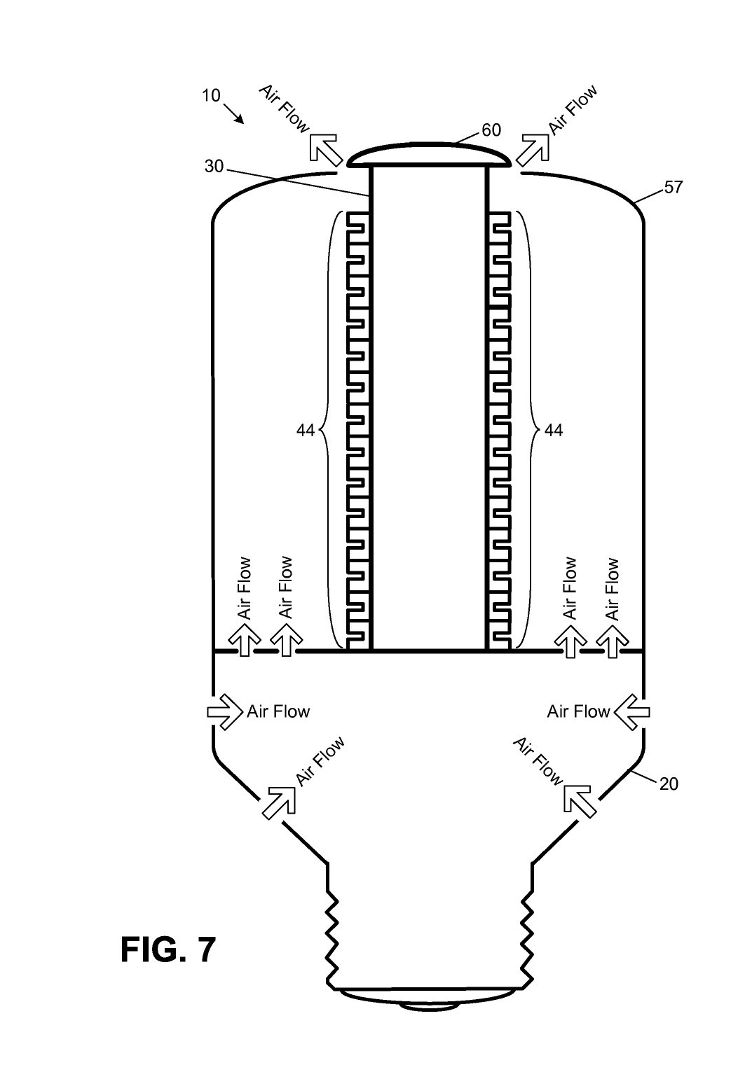

FIG. 6 is a cross-sectional view of an LED bulb according to the first exemplary embodiment of the invention. As shown in FIG. 6, the base 20 houses a power converter 23 that converts alternating current voltage from the screw-in type electrical connector 21 into direct current voltage. The power converter 23 provides the direct current voltage to the interboard connectors 44 through electrical leads 24a and 24b.

In addition to the openings 22 in the sides of the base 20 between the pillar 30 and the screw-in type electrical connector 21, the base 20 also has openings 25 in the side of the base 20 from which the pillar 30 extends. The openings 22 and 25 in the base 20 facilitate air flow through the base 20 to cool the power converter 23. A screen or filter can be provided across the openings 22 in the base 20 to prevent dust intrusion into area within the base 20 containing the power converter 23.

The cover 57 has openings 58 adjacent to the cap 60. The openings 58 in the cover 57 can either be holes or slits. A screen or filter can be provided across the openings 58 in the cover 57 to prevent dust intrusion into the area within the cover 57 containing the LED modules 44.

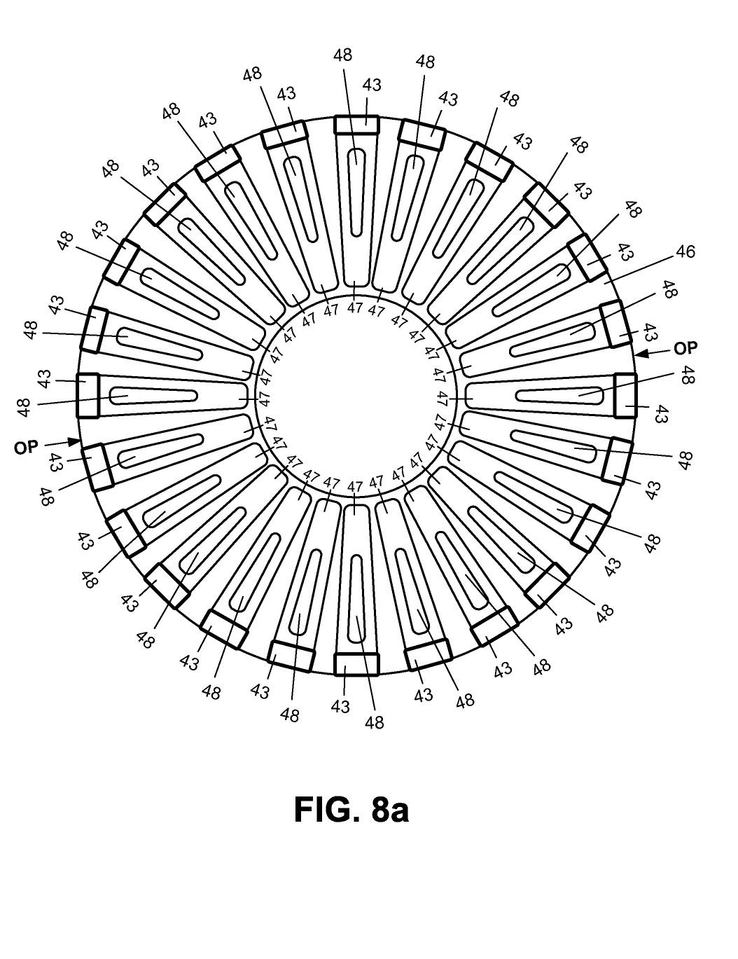

FIG. 7 is a cross-sectional view of an LED bulb showing air flow according to the first exemplary embodiment of the invention. As shown in FIG. 7, the openings in the base 20 and in the cover 57 allow air movement through the base and through the cover such that the LED modules within the cover can be cooled. The circuit boards and side-emitting LEDs of the LED modules are not shown in FIG. 7 so as to show air flow within the cover 57. However, the interboard connectors 44 are shown in FIG. 7 to give an exemplary indication of where complete LED modules are positioned relative to the air flow within the cover 57. Although the air flow is shown going through the base 20 and then into the LED module area within the cover 57 in the LED bulb 10 shown in FIG. 7, the air flow would go through the LED module area within the cover 57 and then into the base 20 when the LED bulb 10 is implemented upside down due to the convection current nature of heated air.

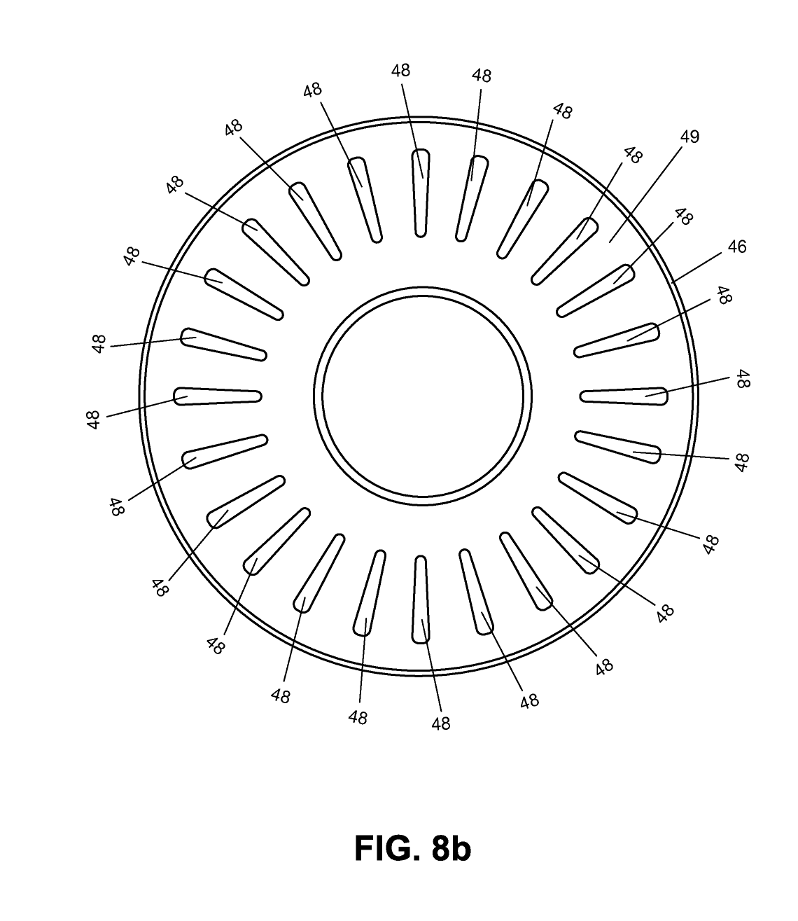

FIG. 8a is a top view of a slotted circuit board with parallel connected LEDs and FIG. 8b is a bottom view of a slotted circuit board with parallel connected LEDs. As shown in FIG. 8a, a circuit board 46 has electrical traces 47 in a radial pattern. Side-emitting LEDs 43 are mounted on the circuit board at the ends of the electrical traces 47 near the outer periphery OP of the circuit board 46. As shown in FIG. 8b, a backplane electrode 49 covers most of the side of the circuit board 46 opposite to the side having the radial electrical traces 47. As shown in both FIG. 8a and FIG. 8b, slots 48 are cut though the electrical traces 47, the circuit board 46 and the backplane electrode 49.

The slots 48 promote air flow through a series of circuit boards 46 when the circuit boards 46 are parts of a stacked plurality of LED modules. Rather than just having air flow past the outer periphery of a circuit as in a series of solid circuit boards in a stacked plurality of LED modules, slotted circuit boards have air flow both past the outer peripheries and through the circuit boards in a stacked plurality of LED modules. The air flow through the circuit boards increases the amount of heat that can be removed from both the electrical traces 47 and the backplane electrode 49, which receive heat from the side-emitting LEDs 43. Such increased heat removal increases the efficiency at which heat can be dissipated from the side-emitting LEDs 43.

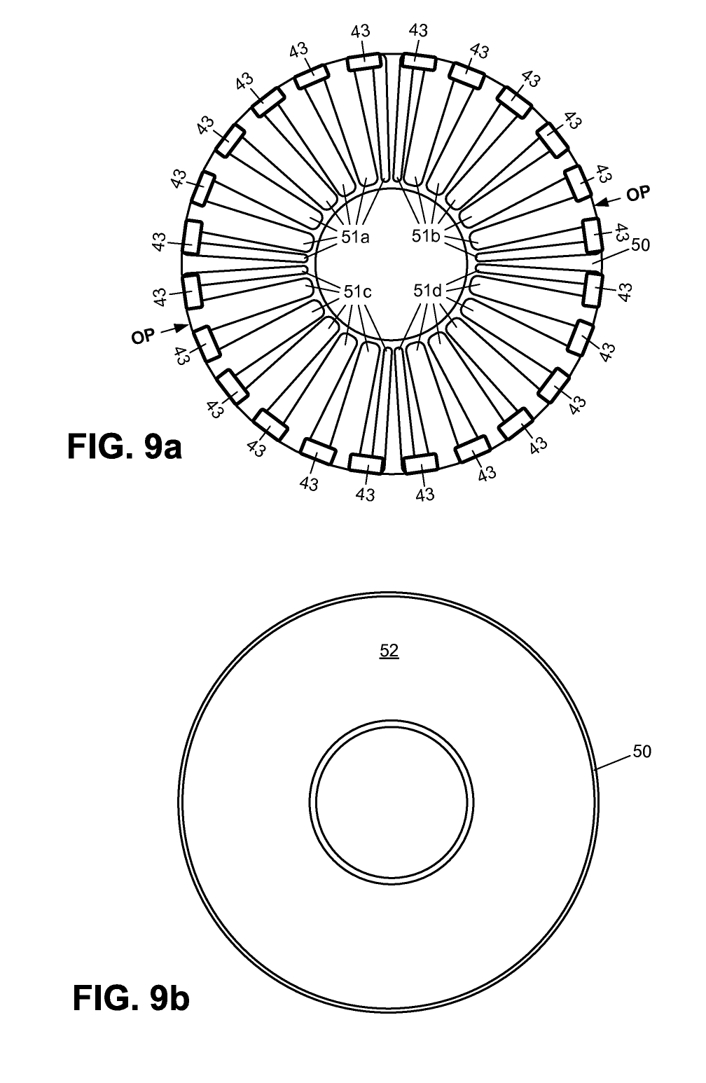

FIG. 9a is a top view of a circuit board with groups of serially connected LEDs and FIG. 9b is a bottom view of a circuit board with groups of serially connected LEDs. As shown in FIG. 9a, a circuit board 50 has groups of electrical traces 51a, 51b, 51c and 51d in a radial pattern. Side-emitting LEDs 43 are mounted on the circuit board at the ends of the groups of radial electrical traces 51a, 51b, 51c and 51d near the outer periphery OP of the circuit board 50. As shown in FIG. 9b, a backplane metal 52 covers most of the side of the circuit board 50 opposite to the side having the groups of radial electrical traces 51a, 51b, 51c and 51d.

The side-emitting LEDs 43 are two terminal devices in which each terminal is respectively connected to a different electrical trace of within a group such that LEDs connected to a group of electrical traces are connected in series. The backplane metal 52 is not used for electrical purposes but still serves as a heat radiator for the side-emitting LEDs 43 through the circuit board 50. A direct current voltage is provided to each of the serial connected groups of LEDs in parallel. An electrical failure in one serially connect group of LEDs connected in parallel to other groups of LEDs will not effect the operation of the other groups of LEDs. Using groups of serially connected LEDs on the circuit board 50 reduces the number and complexity of conductors in the interboard connectors used with the circuit boards to make LED modules.

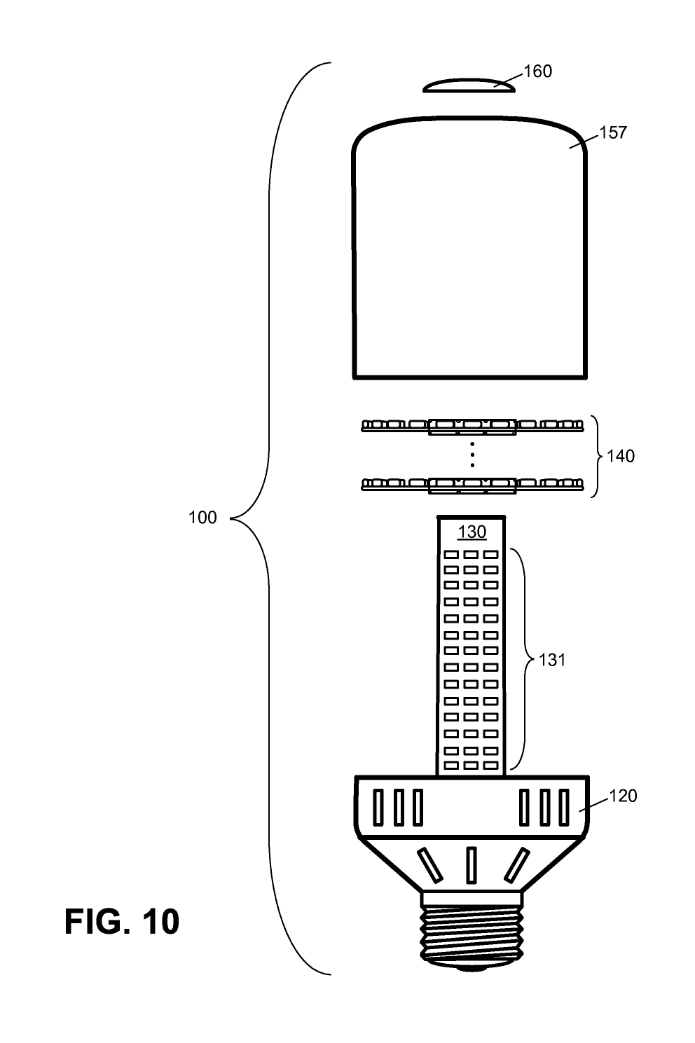

FIG. 10 is an assembly view of an LED bulb according to the second exemplary embodiment of the invention. As shown in FIG. 10, an LED bulb 100 has a base 120 from which a hollow pillar 130 extends, a plurality of LED modules 140 are stacked on the base 120 to surround the hollow pillar 130, a cover 157 is placed over the stacked LED modules, and a cap 160 attaches to the hollow pillar 130 to secure the cover 157. The hollow pillar 130 is perforated with openings 131 along the length of the hollow pillar 130. The assembled LED bulb 100 can be somewhat similar in size and shape to a typical incandescent bulb or a typical compact fluorescent bulb.

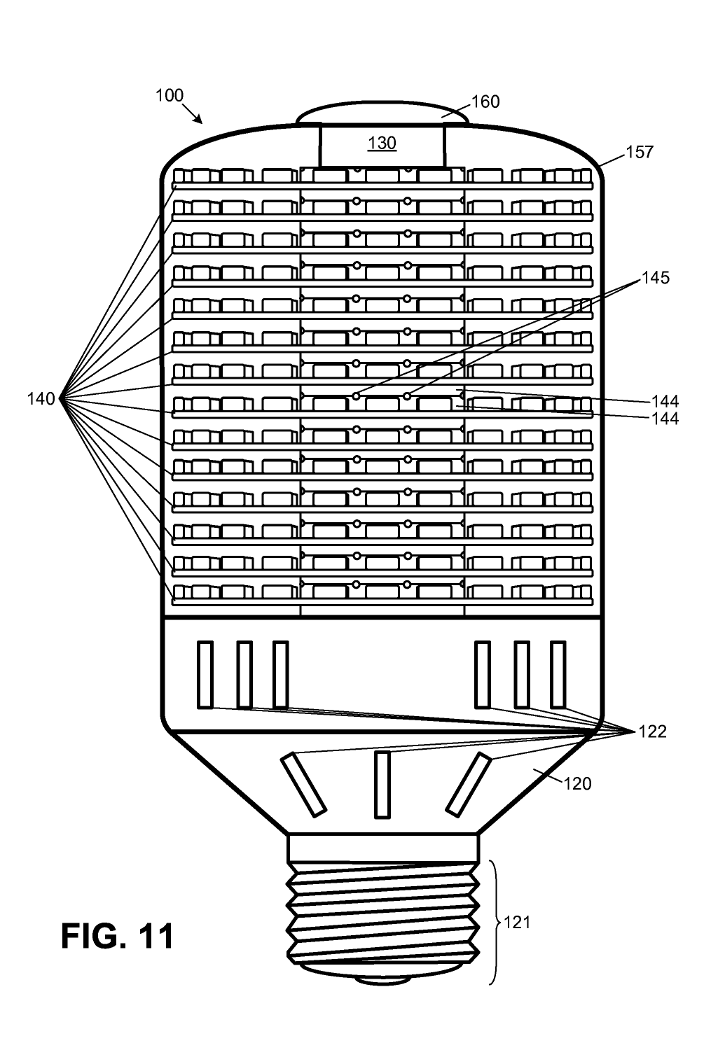

FIG. 11 is a side view of an LED bulb according to a second exemplary embodiment of the invention. As shown in FIG. 11, an LED bulb 100 has a base 120 from which a hollow pillar 130 extends, a plurality of LED modules 140 stacked on the base 120 around the hollow pillar 130, a cover 157 encapsulating the stacked LED modules, and a cap 160 attached to the pillar 130 to secure the cover 157. The hollow pillar 130 is at one end of the base 120 and a screw-in type electrical connector 121 is located at the opposite end of the base 120. The base has openings 122 in the sides of the base 120 between the hollow pillar 130 and the screw-in type electrical connector 121.

As shown in FIG. 11, holes 145 are positioned between each of the stacked modules 140. The holes 145 correspond to the openings 131 in the hollow pillar 130. The openings 131 along the length of the hollow pillar 130 together with the holes 145 enable air flow between the inside of the hollow pillar 130 and the LED module area within the cover 157.

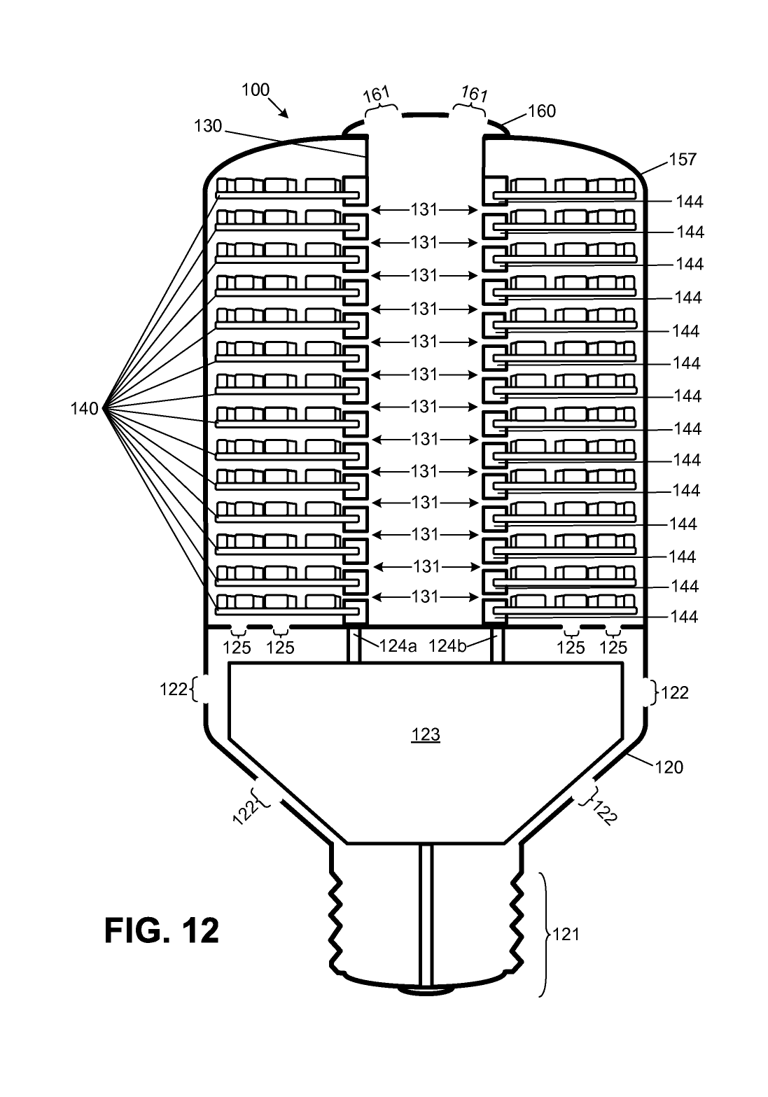

FIG. 12 is a cross-sectional view of an LED bulb according to the second exemplary embodiment of the invention. As shown in FIG. 12, the base 120 houses a power converter 123 that converts alternating current voltage from the screw-in type electrical connector 121 into direct current voltage. The power converter 123 provides the direct current voltage to the interboard connectors 144 through electrical leads 124a and 124b.

In addition to the openings 122 in the sides of the base 120 between the hollow pillar 130 and the screw-in type electrical connector 121, the base 120 also has openings 125 in the side of the base 120 from which the pillar 130 extends. The openings 122 and 125 in the base 120 facilitate air flow through the base 120 to cool the power converter 123. A screen or filter can be provided across the openings 122 in the base 120 to prevent dust intrusion into area within the base 120 containing the power converter 123.

The cap 160 has openings 161 to facilitate airflow in the hollow pillar 130 and through the openings 131 in the hollow pillar 130. The openings 161 in the cap 160 can either be holes, slits or a single hole. A screen or filter can be provided across the openings 161 in the cap 160 to prevent dust intrusion through the openings 131 in the hollow pillar 130 into the area within the cover 157 containing the LED modules 144.

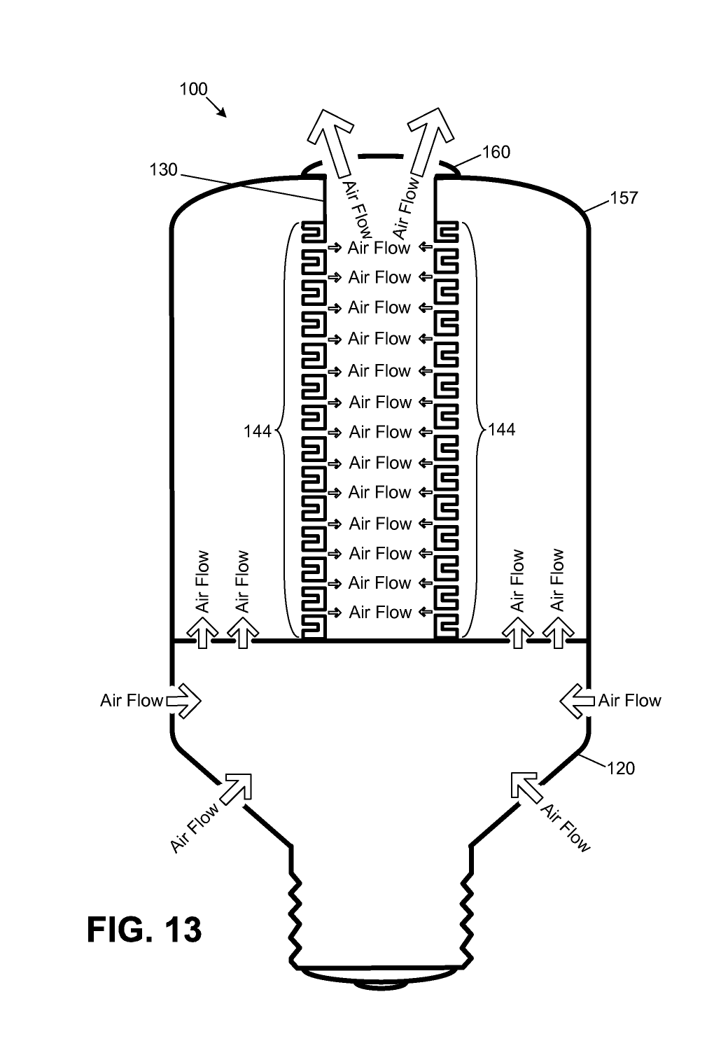

FIG. 13 is a cross-sectional view of an LED bulb showing air flow according to the second exemplary embodiment of the invention. As shown in FIG. 13, the openings in the base 20 and in the hollow pillar 130 and the cap 160 allow air movement through the base, through the hollow pillar past the interboard connectors 144 and through the cover such that the LED modules within the cover 157 can be cooled. The circuit boards and side-emitting LEDs of the LED modules are not shown in FIG. 13 so as to show air flow within the cover 157. However, the interboard connectors 144 are shown in FIG. 13 to give an exemplary indication of where complete LED modules are positioned relative to the air flow within the cover 157. Although the air flow is shown in FIG. 13 going through the base 120 into the LED module area within the cover 157 in the LED bulb 100 and then into the hollow pillar 130 so as to exhaust out the cap 160, the air flow would go through the cap 160, through the hollow pillar 130 past the interboard connectors 144 into the LED module area within the cover 57 and then into the base 20 if the LED bulb 100 was implemented upside down due to the convection current nature of heated air.

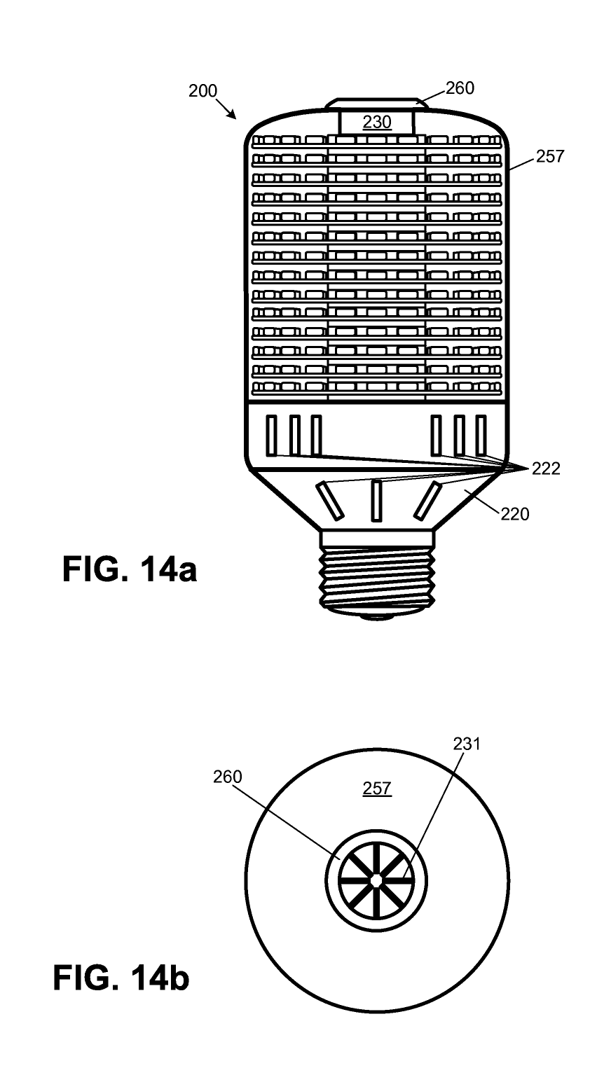

FIG. 14a is a side view of an LED bulb according to a third exemplary embodiment of the invention. As shown in FIG. 14a, an LED bulb 200 has a base 220 from which a hollow pillar 230 extends, a plurality of LED modules 240 stacked on the base 220 around the hollow pillar 230, a cover 257 encapsulating the stacked LED modules, and a cap 260 attached to the pillar 230 to secure the cover 257. The hollow pillar 230 is at one end of the base 220 and a screw-in type electrical connector 221 is located at the opposite end of the base 220. The base has openings 222 in the sides of the base 220 between the hollow pillar 230 and the screw-in type electrical connector 221.

FIG. 14b is a top view of an LED bulb according to the third exemplary embodiment of the invention. As shown in FIG. 14b, the cap 260 has an opening 261 to facilitate airflow in the hollow pillar 230 past fins 231 positioned within the hollow pillar 230. The opening 261 in the cap 260 can be a single opening, multiple holes or slits. A screen or filter can be provided across the opening 261 in the cap 260 to prevent dust intrusion into the hollow pillar 230.

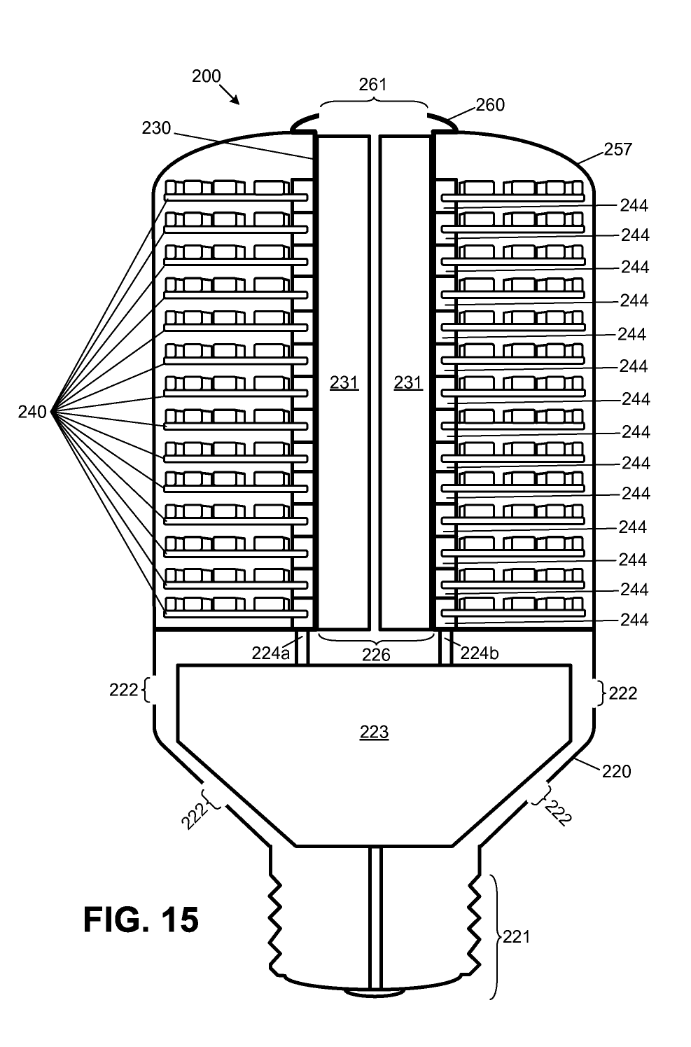

FIG. 15 is a cross-sectional view of an LED bulb according to the third exemplary embodiment of the invention. As shown in FIG. 15, the base 220 houses a power converter 223 that converts alternating current voltage from the screw-in type electrical connector 221 into direct current voltage. The power converter 223 provides the direct current voltage to the interboard connectors 244 through electrical leads 224a and 224b.

In addition to the openings 222 in the sides of the base 220 between the hollow pillar 230 and the screw-in type electrical connector 221, the base 220 also has an opening 226 in the side of the base 220 from which the pillar 230 extends that corresponds to the interior of the hollow pillar 230. The openings 222 and 226 in the base 220 facilitate air flow through the base 220 to cool the power converter 223. A screen or filter can be provided across the openings 222 in the base 220 to prevent dust intrusion into area within the base 220 containing the power converter 223.

The cap 260 has an opening 261 to facilitate airflow in the hollow pillar 230 past the fins 231 in the hollow pillar 230. The opening 261 in the cap 260 can either be a single hole, a plurality of holes or a plurality of slits. A screen or filter can be provided across the opening 261 in the cap 260 to prevent dust intrusion through the openings 231 in the hollow pillar 230 so that fins 261 are not clogged or covered with dust.

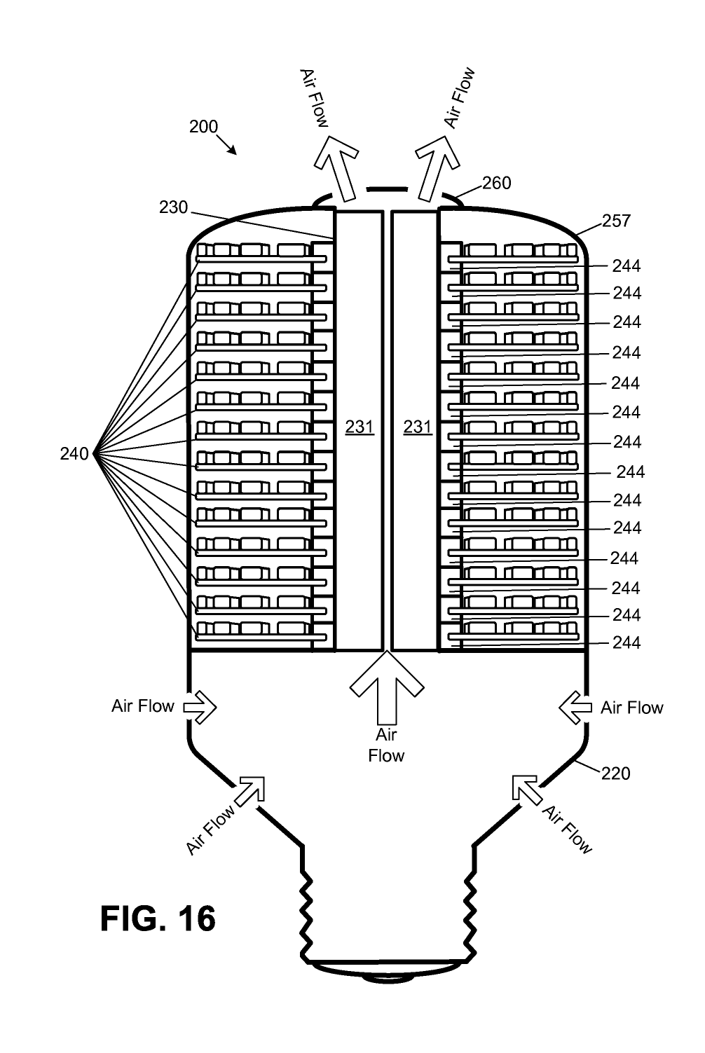

FIG. 16 is a cross-sectional view of an LED bulb showing air flow according to the third exemplary embodiment of the invention. As shown in FIG. 16, the openings in the base 220 and in the cap 260 allow air movement through the base, through the hollow pillar past the fins 231 and out the cap 260 such that the LED modules within the cover 257 can be cooled by heat transfer through the interboard connectors 244 to the hollow pillar 230. Although the air flow in the LED bulb 100 shown in FIG. 16 goes through the base 220 and then into the hollow pillar 230 past the fins 231 so as to exhaust out the cap 260, the air flow would go through the cap 260, through the hollow pillar 230 past the fins 231, and then into the base 220 if the LED bulb 200 was implemented upside down due to the convection current nature of heated air.

Although the preferred embodiments are disclosed having three different air flow paths, embodiments of the inventions can include combinations of the different air flow paths disclosed above. Further, an electrical fan can be provided in either the base or the cap to increase air flow. It will be apparent to those skilled in the art that other various modifications and variations can be made in embodiments of the invention without departing from the spirit or scope of the invention. Thus, it is intended that embodiments of the invention cover the modifications and variations of this invention provided they come within the scope of the appended claims and their equivalents.

What is claimed is:

1. A light emitting diode bulb, comprising:
a base having a screw-in type electrical connector at a first end of the base;
a power converter in the base for converting alternating current voltage into direct current voltage;
a plurality of light emitting diode modules stacked on the base, wherein each of the light emitting diode modules have a plurality of side-emitting light emitting diodes; and
a cover surrounding the plurality of light emitting diode modules stacked on the base.

2. The light emitting diode bulb according to claim 1, further comprising:
a hollow pillar extending from a second end of the base opposite to the first end of the base.

3. The light emitting diode bulb according to claim 2, further comprising heat dissipating fins within the hollow pillar.

4. The light emitting diode bulb according to claim 2, further comprising a cap on the hollow pillar to secure the cover surrounding the plurality of light emitting diode modules.

5. The light emitting diode bulb according to claim 4, further comprising at least a first opening in the cap and second openings in the base such that air can flow through the hollow pillar to cool the light emitting diode modules within the cover.

6. The light emitting diode bulb according to claim 2, further comprising first openings in the hollow pillar and second openings in the base such that air can flow across the plurality of light emitting diode modules within the cover.

7. The light emitting diode bulb according to claim 1, further comprising first openings in the cover and second openings in the base such that air can flow across the plurality of light emitting diode modules within the cover.

8. The light emitting diode bulb according to claim 1, wherein each of the plurality of light emitting diode modules includes:
a circuit board; and
electrical traces on the circuit board in a radial pattern.

9. The light emitting diode bulb according to claim 8, further comprising slits in the circuit board for air flow through the plurality of light emitting diode modules.

10. A light emitting diode bulb, comprising:
a base having an electrical connector at a first end;
a pillar extending from a second end of the base opposite to the first end of the base;
a power converter in the base for converting alternating current voltage into direct current voltage;
a plurality of light emitting diode modules stacked on the base and surrounding the pillar, wherein each of the modules have a plurality of side-emitting light emitting diodes; and
a cover surrounding the plurality of light emitting diode modules.

11. The light emitting diode bulb according to claim 10, further comprising first openings in the pillar and second openings in the base such that air can flow across the plurality of light emitting diode modules within the cover.

12. The light emitting diode bulb according to claim 10, further comprising first openings in the pillar between the plurality of light emitting diode modules and second openings in the base such that air can flow through the pillar to cool the light emitting diode modules within the cover.

13. The light emitting diode bulb according to claim 10, further comprising first openings in the cover and second openings in the base such that air can flow across the plurality of light emitting diode modules within the cover.

14. The light emitting diode bulb according to claim 10, wherein each of the plurality of light emitting diode modules includes:
a circuit board; and
electrical traces on the circuit board in a radial pattern.

15. A light emitting diode bulb, comprising:
a base having an electrical connector at a first end;
a pillar extending from a second end of the base opposite to the first end of the base;
a power converter in the base for converting alternating current voltage into direct current voltage;
a first light emitting diode module having a first inner periphery surrounding the pillar and a first outer periphery opposite to the first inner periphery;
a first plurality of side-emitting light emitting diodes at the first outer periphery;
a second light emitting diode module having a second inner periphery surrounding the pillar and a second outer periphery opposite to the second inner periphery; and
a second plurality of side-emitting light emitting diodes at the second outer periphery; and
a cover surrounding the first and second light emitting diode modules.

16. The light emitting diode bulb according to claim 15, further comprising first openings in the pillar and second openings in the base such that air can flow across the plurality of light emitting diode modules within the cover.

17. The light emitting diode bulb according to claim 15, further comprising first openings in the pillar and second openings in the base such that air can flow through the pillar to cool the light emitting diode modules within the cover.

18. The light emitting diode bulb according to claim 15, further comprising first openings in the cover and second openings in the base such that air can flow across the plurality of light emitting diode modules within the cover.

19. The light emitting diode bulb according to claim 15, wherein each of the first and second light emitting diode modules includes:
a circuit board; and
electrical traces on the circuit board in a radial pattern.

20. The light emitting diode bulb according to claim 19, further comprising slits in the circuit boards for air flow through the first and second light emitting diode modules.
